(19) United States
(12) Patent Application Publication
(10) Pub. No.: US 2008/0040882 A1
(43) Pub. Date: Feb. 21, 2008

(54) Tunnel Car Wash

(75) Inventor: Claude Duterme, Troyes (FR)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Tunnel De Lavage, Troyes (FR)

(21) Appl. No.: 11/662,448

(22) PCT Filed: Jun. 29, 2005
(86) PCT No.: PCT/FR05/50512

§ 371 Date: Mar. 9, 2007

(30) Foreign Application Priority Data
Sep. 14, 2004 (FR) 0452036

(51) Int. Cl. B60S 3/06

(52) U.S. Cl. 15/319; 15/321; 15/53.3

(57) ABSTRACT

A vehicle wash and wax system comprising a liquid coating dispensing station and a waterfall dispensing station to dump a continuous sheet of fluid onto the liquid coating on the surface of the vehicle. The waterfall dispensing station has a tank structure with a weir member to form the continuous liquid sheet dump. Chemical agents, such as optical brighteners, dyes and a carnauba wax emulsion may be introduced in the waterfall dispensing station for the continuous liquid sheet dump.

### FIELD OF THE INVENTION

The present invention relates to a washing tunnel for vehicles, comprising a wetting entrance and a pre-wash arch, cleaning, rinsing and drying means.

### PRIOR ART

There are various forms of washing tunnel of the type defined above.

FIG. 1 gives an example of a washing installation formed by two washing tunnels having different functions. The two washing tunnels are optionally joined at their exits to a polishing portal structure.

In greater detail, the vehicle washing tunnel having two tunnels is composed of a wetting and preparation entrance E in which the vehicle is prepared (aerials and windscreen wipers are fixed, where appropriate the aerial is removed, the wing mirrors are folded in).

After that preparatory step, the vehicle can pass into the high-pressure washing tunnel 1 or into the roller washing tunnel 2.

The high-pressure washing tunnel 1 is composed of a transportation means 11 for carrying the vehicle through the various wash stations. The high-pressure washing tunnel 1 is equipped with a pre-wash arch A1, which is followed by a high-pressure washing portal structure P2. The high-pressure washing portal structure P2 is a portal structure that is equipped with nozzles distributed over its sides and its top in order to direct onto the vehicle water in the form of broad high-pressure jets. The nozzles are mounted on movable equipment so that they are able to come close to the vehicle body, both at the sides and the top. The portal structure moves relative to the vehicle and passes over it from front to back and vice versa. It cleans the lower part of the bodywork including the wheels, the sides and the underside.

After the high-pressure portal structure P2, the vehicle passes through a rinse arch A7, which sprays rinsing liquid, optionally with wax, and finally it passes into the drying portal structure P7, which is formed by nozzles that direct fierce jets of air onto the vehicle body in order to drive off the liquid and dry the vehicle body.

The roller washing tunnel 2, like the high-pressure washing tunnel, is composed of a vehicle transportation track equipped with means such as a carriage that push or pull the vehicle through the tunnel between the entrance and the exit. At its entrance, the tunnel comprises a pre-wash arch A1, which is followed by one or two roller portal structures P3, P4. The roller portal structures each comprise two vertical rollers for cleaning the sides of the vehicle body and an upper, horizontal roller, which cleans the top of the vehicle body.

After the roller portal structure(s), the tunnel comprises a rinse arch A7, which is followed by a drying portal structure P8.

Vehicles that have passed through the high-pressure washing tunnel HP or the roller washing tunnel can leave the installation directly. Dry vehicles can likewise pass through a polishing installation 3, which is composed of a polishing portal structure P9 formed by polishing rollers and a polishing agent dispenser. The polishing rollers are rollers having textile ribbons, which polish the vehicle body at the same time as a polishing agent is directed onto it.

Although that known installation functions in a satisfactory manner, it nevertheless has the disadvantage of being complicated and, accordingly, expensive, because it is composed of two washing tunnels each having its own function. The high-pressure washing tunnel comprises stations that cannot be separated. The roller tunnel comprises stations whose functions can be separated. Accordingly, washing is not necessarily associated with drying at the exit. Cleaning can be more or less intensive with the use of one roller portal structure or the two roller portal structures.

Finally, the polishing installation is a possibility that is offered at the exit of the two installations provided that the vehicle is dry, because polishing can be carried out in that installation only if the vehicle has been dried.

This possibility likewise has the disadvantage that there is a risk of malfunctioning if the vehicle is dry but has not been adequately cleaned, it being possible for the particles of sand attached to the vehicle body to be carried along by the rollers of the polishing portal structure and scratch the vehicle body.

In addition to the complexity of the actual installation, it is also inconvenient for the user first to have to pass through one of the tunnels in order to reach the polishing installation.

### OBJECT OF THE INVENTION

The object of the present invention is to develop a vehicle washing installation in which polishing is possible and the space requirement of the installation is reduced so as to be limited to a single vehicle track, which installation offers all wash possibilities among high-pressure washing, washing by means of rollers, and polishing.

### DESCRIPTION AND ADVANTAGES OF THE INVENTION

To that end, the invention relates to a vehicle washing installation composed of a single washing tunnel, characterised in that
the line along which the vehicle passes comprises, in order, downstream of the pre-wash arch,
   a high-pressure portal structure,
   one or more roller portal structures each preceded by a foam-dispensing arch,
   a polishing portal structure preceded by a foam-dispensing arch,
   a rinse arch,
   a drying portal structure,
the central control unit receiving the user's selection (wash program) and controlling operation of the arches and portal structures,
the central control unit including an operating combination of the high-pressure portal structure and of the portal structures that authorises operation of the polishing portal structures as polishing portal structures only if the high-pressure portal structure has previously been operated by the wash program selected by the user.

The washing tunnel according to the invention not only simplifies the installation of the equipment, because there is a single track that is followed by the vehicles whatever the selected wash program and option. According to the invention it is possible to selected various wash programs, and there are options within each program. The programs and options are not described in detail here. Some are shown by way of example in FIG. 3. These multiple possibilities integrated into the integration constituted by a single washing tunnel avoid the duplication of means as in the installation of the prior art and permit more efficient use of the means common to the various wash programs and operations. The invention also makes it possible to avoid any poor operation, in particular at the level of the polishing portal structure, and the consequences that such poor operation can have on the condition of the vehicle body.

The washing tunnel also operates more quickly than the juxtaposition of two washing tunnels followed by a polishing installation, because the operations follow one another directly without interruption, the vehicle being carried through the various stations including the polishing installation.

Dissociation of the functions, that is to say those of the arches and of the portal structures, permits great diversity in terms of programs and options without affecting the fluidity of passage of the vehicles through the tunnel. Several vehicles with different programs and options can pass through the tunnel one after the other.

Advantageously, the roller portal structures, which are located downstream of the high-pressure portal structure and are preceded by a foam-dispensing arch, are equipped with rollers having strips of plastics material, and those portal structures can be controlled to operate as cleaning portal structures, in which case they are wet, with the projection of water and cleaning fluid, and the arches are non-operational, or alternatively as polishing rollers, in which case they are dry but the foam-dispensing arches are operational.

In an interesting manner, the pre-wash arch is equipped with two banks of nozzles, of which one dispenses the washing liquid and the other the polishing foam, the first bank operating on its own or in conjunction with the second bank.

According to another advantageous feature, the logic function ET is integrated into the operating programs and options of the central control unit, which facilitates production of the installation and the taking into consideration of any modifications thereto, the replacement of a piece of equipment, etc.

According to another advantageous feature, control of the operating cycles of the stations of the tunnel is effected by the central control unit.

### DRAWINGS

The present invention will be described in greater detail hereinbelow by means of an embodiment shown in the accompanying drawings, in which:

FIG. 1 is a diagram of a system of washing tunnels according to the prior art,

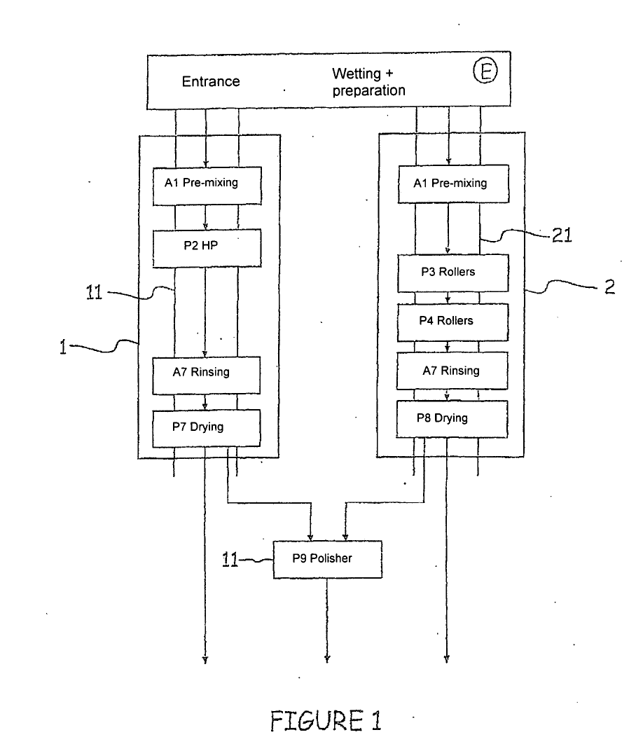

FIG. 2 is a diagram of a washing tunnel according to the invention,

FIG. 3 is a table of possible combinations for wash programs.

### DESCRIPTION OF AN EMBODIMENT

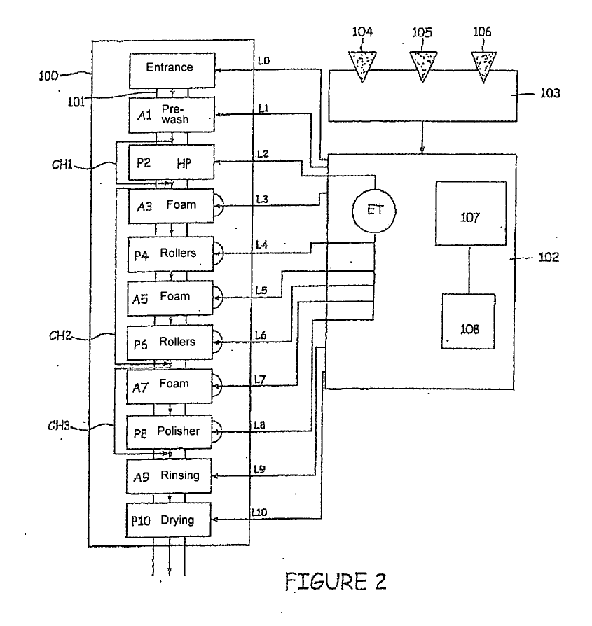

According to FIG. 2, the invention relates to a washing tunnel for vehicles that is equipped with a succession of arches and portal structures having different functions. Those separate arches and portal structures are connected to a control station that receives the users' selections (programs and options) and controls the operating cycle of the pieces of equipment in the washing tunnel.

In order not to clutter up the drawings and complicate the description, known means, such as the vehicle transport track with the means for carrying the vehicle, the arches and portal structures and the equipment thereof, such as the nozzles and rollers, are not shown and a detailed description thereof will not be given.

The tunnel 100 comprises a vehicle passage line 101. The line is equipped with rails and a carriage or conveyor which moves the vehicle from the entrance to the exit between the various stations formed by the arches and portal structures, in order to carry out the operations requested by the customer. In reality, there is a plurality of carriages or drive wheels carried by an endless chain for carrying several vehicles through the tunnel one after another, whether or not the vehicles have selected the same wash program or different programs, as well as different options within the programs.

The stations are constituted by an entrance E for introducing the vehicle onto the transportation track, with manual preparation of the vehicle and wetting. In that wetting zone, the vehicle is cleaned manually by application of a cleaning or washing product and removal of dirt by means of a high-pressure jet. This first cleaning operation allows the vehicle to be practically cleaned in order to remove therefrom “roughnesses” such as grains of sand so as to prevent such grains or “roughnesses” from subsequently scratching the vehicle body when they are carried along by the rollers.

The entrance station E is equipped with a pre-wash arch A1, which is equipped with a bank of nozzles R1 for directing pre-wash foam onto the vehicle. A second bank of nozzles R2 allows polishing foam to be directed onto the vehicle. The pre-wash arch A1 dispenses pre-wash foam whatever the selected program or option. However, in the case of programs with only high-pressure washing (portal structure P2), a polishing foam is added to the pre-wash foam, the two types of foam being dispensed by each bank of nozzles R1, R2. In the case of the dispensing of polishing foam, the high-pressure portal structure P2 spreads the polishing foam and creates a shine because there is no rubbing.

The pre-wash arch A1 is followed by the high-pressure portal structure P2 equipped with high-pressure water nozzles which clean the vehicle body and the chassis. The nozzles are distributed over the sides and the top. The lateral nozzles are located opposite the vehicle, and the top nozzles are carried by a transverse member, which is equipped with tracking cells for controlling the downward or upward movement of the nozzles by following the outline of the vehicle body. The tunnel 100 then comprises one or two roller portal structures P4, P6 each preceded by an arch A3, A5 equipped with banks of nozzles for dispensing polishing foam. Each portal structure has two vertical rollers and a horizontal roller for treating the sides and the top of the vehicle. The rollers are formed by strands or strips of plastics material. The strips are in fact cut into disks of plastics material stacked one on top of the other on the shaft of the roller. The assembly of portal structures P4, P6 has a dual function:
the portal structures can operate as cleaning rollers, with the projection of water with added washing agents,
the portal structures can operate as polishing rollers if the foam-dispensing arches A4, A5 are activated.

That polishing function is possible if the vehicle has previously undergone cleaning in the high-pressure portal structure P2.

Otherwise, that option is not possible.

The rollers having strips of plastics material of the two portal structures P4, P6 permit that dual function because they do not become impregnated with washing foam or polishing foam. Owing to the plastics material, the rollers of the portal structures P4, P6 carry out pre-polishing. The roller(s) of the portal structures execute(s) a relative movement in relation to the vehicle. The portal structures P4, P6 operating for cleaning with washing liquid allow any residues of traffic film that may remain on the vehicle to be removed. This is in fact the deposition of the very fine layer of dirt and dust that adheres to the vehicle body.

Downstream of the roller portal structure P6 there is an arch A7 which also sprays polishing foam onto the vehicle. Spraying is effected by means of nozzles, the vehicle being moved relative to the fixed arch A7.

The polishing-foam arch A7 is followed by a polishing portal structure P8, which is composed of a frame equipped with three polishing rollers of textile material (felt), two lateral rollers and an upper, horizontal roller. The portal structure is completely fixed. The conveyed vehicle passes beneath the portal structure, and the rollers follow the contour of the vehicle. The rollers move longitudinally relative to the vehicle, following the contours thereof.

The rollers that compose this portal structure, which is likewise fixed, are formed by narrow bands of material which carry out the polishing. As in the other polishing portal structures, the operation is carried out dry, the rollers spreading the foam and polishing the vehicle body. The rollers do not themselves dispense products.

Downstream of the polishing portal structure P8, a rinse arch A9 sprays the vehicle with hot or cold wax and rinses it with osmosed water. Rinsing is necessary in order to remove residues of polishing foam that may remain on the vehicle body and would interfere with drying.

The rinse arch A9 is followed by a drying portal structure P10 comprising nozzles that blow air onto the vehicle body.

The installation also comprises a central control unit 102 connected to a data input 103. The input 103 is composed of a keyboard 104 and one or more card readers 105, 106, allowing the user to introduce his command, that is to say the choice of wash program, using a special card corresponding to the chosen wash program or a credit card, the wash program then being selected using the keyboard or, alternatively, by an operator at the tunnel entrance. The information is transmitted to the central control unit, which is equipped with a microprocessor or a programmable automatic device that controls start-up of the stations in the tunnel. It also comprises a memory 108 containing the various wash programs and options. The lines for transmitting the instructions from the control station 102 to the stations E, A1 . . . P10, and any return signals, bear the reference numerals L0 to L10. The control signals sent to the stations E to P10 are signals for initiating an operating cycle. By way of variation, they can also be the succession of signals of an operating cycle, according to whether management of the operation of the tunnel is decentralised to the different stations or is combined in the central control unit. The latter solution is the most valuable in terms of effective management, because it allows operating signals sent in return by the various stations E to P10 to the central control unit 102 to be taken into account directly. The central control unit 102 includes a logic combination ET, which authorises operation of the polishing portal structures P4, P6, P8 only if the high-pressure portal structure P2 has been used previously and in the same program or option. This combination is shown diagrammatically in the control station by the logic function ET connecting the lines of the portal structures P2 and P4, P6, P10. The logic function ET so demonstrated can be produced by means of the cabling of the circuit, but it is preferably recorded in the programs contained within the memory 108 of the microprocessor 107.

Operation of the separate stations A1 to P10 of the actual tunnel is requested by the control station 103.

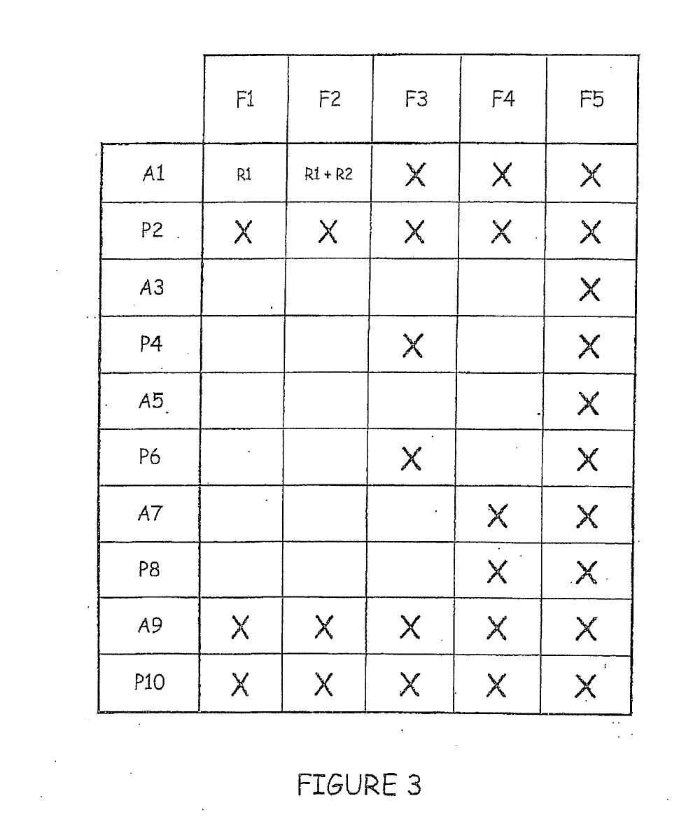

FIG. 3 shows various possibilities for the use of the stations of the tunnel. Accordingly, the high-pressure portal structure P2 can be bypassed (path CH1). The same is true of the roller portal structures P4, P6 and of the polishing portal structure P8 with the foam-dispensing arch A7 preceding it (paths CH2, CH3).

FIG. 3 shows diagrammatically a table of different use possibilities of the washing tunnel.

The first column shows the stations of the washing tunnel: the arch A1, the portal structure P2, the arch A3, the portal structure P4, the arch A5, the portal structure P6 followed by the arch A7, the portal structure P8, the arch A9 and the portal structure P10. Subsequent columns indicate which boxes are occupied and the number of the stations used in the various wash programs and options bearing the reference numerals F1, F2, F3, F4, F5. The combinations are recorded in the memory 108 of the processor 107 of the central control unit 102.

The table shows in particular that the foam-dispensing arches A3, A5, A7 and the polishing portal structures P4, P6, P8 can be used only if the vehicle has previously passed through the high-pressure washing portal structure P2.

As is shown diagrammatically in FIG. 3, the data input 103 allows the programs and options to be selected.

In practice, the selection of programs and options can be made from two different stations by means of two desks connected to one another.

Depending on the frequency of use of the installation, the selection of programs and options is made either at the station, for example at the main cash desk, or at a station located at the entrance to the washing tunnel. Those stations are used by different people. The main station, which is located at the cash desk, is used by a cashier, and the station located at the entrance to the washing installation is used by the operator who positions the vehicle on the conveyor and prepares it.

When the installation is used with high frequency, the two stations are occupied, the main station dealing with the selection of programs and options and the station at the entrance to the chain is then vacant.

When the installation is used with low frequency, only the station at the entrance to the washing tunnel is used by the operator, who both collects payment and prepares each vehicle.

1. Tunnel for washing vehicles, comprising a wetting entrance and a pre-wash arch, cleaning, rinsing and drying means, characterised in that
the line of passage of the vehicle comprises, in order, downstream of the pre-wash arch (A1),
a high-pressure portal structure (P2),
one or more roller portal structures (P4, P6) each preceded by a foam-dispensing arch (A3, A5, A7),
a polishing portal structure (P8) preceded by a foam-dispensing arch (A7),
a rinse arch (A9),
a drying portal structure (P8),
the central control unit (102) receiving the user's selection (wash program) and controlling operation of the arches and portal structures,
the central control unit (102) including a combination of operation of the high-pressure portal structure (P2) and of the portal structures (P4, P6, P8) which authorises operation of the polishing portal structures (P4, P6, P8) as polishing portal structures only if the high-pressure portal structure (P2) has previously been operated by the wash program selected by the user.

2. Washing tunnel according to claim 1,
characterised in that
the roller portal structures (P4, P6), which are located downstream of the high-pressure portal structure (P2) and are preceded by a foam-dispensing arch (A3, A5), are equipped with rollers having strips of plastics material, and the portal structures can be controlled in order to operate as cleaning portal structures, in which case they are wet, with the projection of water and cleaning fluid, and the arches (A3, A5) are non-operational, or alternatively as polishing rollers, in which case they are dry but the foam-dispensing arches (A3, A5) are operational.

3. Washing tunnel according to claim 1,
characterised in that
the pre-wash arch (A1) is equipped with two banks of nozzles (R1, R2), of which one dispenses washing fluid and the other polishing foam, the first bank (R1) operating on its own or in conjunction with the second bank (R2).

4. Washing tunnel according to claim 1,
characterised in that
the logic function (ET) is integrated into the operating programs or options of the central control unit (102).

5. Washing tunnel according to claim 1,
characterised in that
control of the operating cycles of the stations (E to P10) of the tunnel is effected by the central control unit (102).
